(19) United States
(12) Patent Application Publication
(10) Pub. No.: US 2005/0091623 A1
(43) Pub. Date: Apr. 28, 2005

(54) Method and apparatus for computer-aided creation of a clock tree structure file, a method for computer-aided creation of a layout for a semiconductor circuit, and a computer-readable storage media

(75) Inventors: Thomas Zettler, Hohenkirchen-Siegertsbr (DE); Heinz Endres, Gaukonigshofen (DE)

Correspondence Address: DARBY & DARBY P.C., P. O. BOX 5257, NEW YORK, NY, 10150-5257, US

(73) Assignee: Infineon Technologies AG, Munich (DE)

(21) Appl. No.: 10/922,791

(22) Filed: Aug. 19, 2004

(30) Foreign Application Priority Data
Aug. 22, 2003 (DE) 103 38 745.5

(51) Int. Cl. G06F 9/45; G06F 17/50

(52) U.S. Cl. 716/6; 713/500

(57) ABSTRACT

Method for computer-aided creation of a clock tree structure file for a semiconductor circuit, which has a plurality of synchronously driven switching elements and a plurality of signal connections. A first reference switching element is selected from the plurality of synchronously driven switching elements. A first reference arrival time of a clock signal is defined for the first reference switching element. A clock signal arrival interval is determined for at least one switching element from the plurality of synchronously driven switching elements, which is coupled to the first reference switching element via at least one of the plurality of signal connections. An arrival time of a clock signal for the at least one switching element within the clock signal arrival interval, whose value is not the same as the first reference arrival time, is defined. The first reference arrival time and the defined arrival time are stored in the clock tree structure file.

### CROSS-REFERENCE TO RELATED APPLICATION

This application is based on German Patent Application Serial No. 103 38 745.5 filed Aug. 22, 2003.

### FIELD OF THE INVENTION

The present invention relates to a method and an apparatus for computer-aided creation of a clock tree structure file for an integrated semiconductor circuit having a multiplicity of synchronously driven switching elements and a multiplicity of signal connections, to a method for computer-aided creation of a layout for a semiconductor circuit, and to a computer-readable storage media.

### BACKGROUND OF THE INVENTION

The continuously increasing complexity of integrated semiconductor circuits is leading to a range of requirements for the design of a circuit architecture. In mobile applications, such as mobile telephones, PDAs, etc., for example, it is necessary to minimize the current that is drawn. Unless special precautions are taken, increased surge currents occur in the voltage supply for the integrated semiconductor circuit with the number of switching elements, such as logic gates, flip-flops, etc. In most cases, the maximum current surges project considerably from the average current profile, and thus require appropriate overdesign of the voltage supply unit.

This problem is made worse, in particular because the aim when designing clock tree structures within the integrated semiconductor circuit is, from the functional point of view, to achieve minimum delay time differences between the clock signals at the switching elements. The production of a clock tree structure such as this is known, for example, from Neil H. E. Weste and Kamram Eshragian; “Principles of CMOS VLSI Design”, page 239, ISBN 0-201-53376-6.

One reason for the need for absolute synchronicity between the switching elements is the switching preconditions which every switching element must comply with. These switching preconditions can be subdivided into two categories. The set-up time defines how long input signals at a switching element must be stable before the next clock pulse is switched on. The hold time or the “hold” in contrast defines how long the input signals at the switching element must remain stable after a clock pulse, that is to say by way of example after a rising or a falling edge of the clock pulse. Contravention of the switching preconditions would result in the switching element being in a metastable state.

If all the switching elements are clocked at the same time in compliance with the functional reliability, then this leads to all the charge-reversal current surges that occur at the switching elements being added up. The existence of charge-reversal current surges results in a range of complex features on and in the chip.

In order to ensure an adequate supply to all the components and switching elements, the metal supply lines are designed for the current that is drawn. This is done, as a maximum, by the sum of the charge-reversal current surges. The necessary broadening of the metal supply lines leads to additional area being consumed on the chip, and thus to increased costs for its production. In the same way, an increased number of supply pads and bonding connections are required on the chip, which leads to a further increase in the production costs.

Owing to the increased current that is drawn, the voltage regulators in the integrated semiconductor circuit are likewise correspondingly overdesigned. This is the only way to guarantee a stable supply during a maximum current surge.

Radio-frequency voltage fluctuations are transmitted via the voltage supply line to the other components on a board on which the integrated semiconductor circuit is located. This results in a reduction in the electromagnetic compatibility (EMC) of the module.

The use of buffer capacitances for smoothing the profile of the current that is drawn is known from the document West et al., which was cited initially. This is once again associated with the disadvantage that an increased area requirement for the buffer capacitances results in increased production costs. Furthermore, the production yield is reduced as a result of additional areas that are sensitive to defects, owing to the implementation of the buffer capacitances in the integrated semiconductor circuit.

### SUMMARY OF THE INVENTION

The present invention is based on the problem of avoiding the difficulties mentioned above with synchronously clocked semiconductor circuits, and of specifying a method and an apparatus by means of which, during creation of a clock tree structure in an integrated semiconductor circuit, which can be kept as low as possible, and of specifying a method by means of which a semiconductor circuit layout can be created which has a clock tree with the stated characteristics.

The problem is solved by a method for computer-aided creation of a clock tree structure file, a method for computer-aided creation of a layout for a semiconductor circuit, and by an apparatus for creation of a clock tree structure file having the features claimed in the independent patent claims.

A method for computer-aided creation of a clock tree structure file for a semiconductor circuit which has a multiplicity of synchronously driven switching elements and a multiplicity of signal connections has the following steps:
a) selection of a first reference switching element from the multiplicity of synchronously driven switching elements,
b) definition of a first reference arrival time of a clock signal for the first reference switching element,
c) determination of a clock signal arrival interval for at least one switching element from the multiplicity of synchronously controlled switching elements, which is coupled to the first reference switching element via at least one signal connection,
d) definition of an arrival time of the clock signal for the switching element within the clock signal arrival interval, whose value is not the same as the first reference arrival time, and
e) storage of the first reference arrival time, and of the arrival time in the clock tree structure file.

In the case of a method for computer-aided creation of a layout for a semiconductor circuit, the method is used for computer-aided creation of a clock tree structure file and, on the basis of the clock tree structure file, defines the placing and the layout of a clock tree within the semiconductor circuit.

A processor is provided for an apparatus for creation of a clock tree structure file, and is designed such that method steps as claimed in the method for computer-aided creation of a clock tree structure file can be carried out.

Furthermore, computer-readable storage media are provided, in which a computer program is stored for creation of a clock tree structure file or for creation of a layout for a semiconductor circuit which, when it is run by a processor, has method steps for a method according to the invention.

One basic idea of the invention is that the creation of current surges in the supply voltage of a semiconductor circuit can be largely avoided even at the design stage of the clock tree structure for the semiconductor circuit. The arrival times of the clock signal at the switching elements are shifted with respect to one another for this purpose, although the functionality of the circuit is not adversely affected.

The clock tree structure uses clock connections to distribute a clock signal to the synchronously driven or synchronously clocked switching elements. This structure may be designed in the form of a clock distribution structure (clock trunk) with no branches or scarcely any branches, or in the form of a tree-like structure (clock tree). The length of the clock connections determines the delay time for the clock signal, and hence the arrival time of the clock signal at the switching element. The clock tree structure may also have delay elements which are connected in the clock connections and are used to increase the delay time of the clock signal, thus making it possible to define the arrival times precisely.

Preferred refinements of the invention result from the dependent patent claims.

The refinements which are described in the following text relate both to the methods, to the apparatus and to the computer-readable storage element.

In one refinement, the clock signal arrival interval is determined taking into account the first reference arrival time and a set-up time and/or a hold time of the first reference switching element.

This ensures that the arrival time is shifted only when the corresponding switching preconditions are still satisfied at the switching elements, or at least can be reproduced.

In a further refinement, step c) is repeated at least for one further switching element from the multiplicity of synchronously driven switching elements, which further switching element is coupled to the first reference switching element via at least one signal connection, with the arrival time being defined within the clock signal arrival interval, and being stored in the clock tree structure file.

In this case, in all those switching elements which are directly or indirectly coupled to the first reference switching element, the arrival times of the clock signal are shifted. These switching elements form a logic cluster within the integrated semiconductor circuit. Those switching elements are designated as switching elements being directly coupled with each other that are connected with each other via a signal connection. In the case of switching elements that are indirectly coupled to each other, a signal path is led between themselves and via at least on further switching element.

In a development, step c) is repeated for all the switching elements from the multiplicity of synchronously driven switching elements which are coupled to the first reference switching element via at least one signal connection, and wherein the arrival time is defined within the clock signal arrival interval and is stored in the clock tree structure file.

Thus, as far as possible, all of the switching elements are taken into account in shifting of the arrival times of the clock signal, with the aim of achieving as optimum a result as possible for the reduction in the total current.

In a further development, a clock signal arrival interval is determined taking into account the arrival times, set-up times and hold times of the switching elements, whose arrival times are already defined.

The arrival time is advantageously defined within the clock signal arrival interval such that a first optimization value, which is determined from the arrival times, is determined to be a minimum.

One particular advantage in this case is the calculation of a single global optimization variable, which is used as a measure for the quality of the method steps carried out. This makes it possible to quickly assess the distribution of the arrival times when changing more than one arrival time.

In one refinement, the first optimization value is chosen such that a minimum first optimization value corresponds to a maximum variance of a statistical distribution function of the arrival times.

This results in the distribution function of the current drawn by the synchronously driven switching elements being as wide as possible. The peak current is considerably less than when the current is drawn synchronously.

In a further refinement, the arrival time within the clock signal arrival interval is defined such that the first optimization value is determined to be a minimum, and the arrival time is then shifted within the clock signal arrival interval such that a second optimization value, which is determined from the arrival times, is determined to be a minimum.

The two-stage matching of the arrival times first of all allows the distribution function of the arrival times to be designed to be as flat as possible at this stage. The optimum distribution determined in this way for the arrival times within the corresponding clock signal arrival intervals is used as the starting point for a further optimization step, which allows an additional reduction in the switching elements which switch at the same time, or allows a specific characteristic for the distribution function of the arrival times.

In one development, the second optimization value is chosen such that a minimum second optimization value corresponds to a maximum discrepancy between the fourth moment of the statistical distribution function of the arrival times and the fourth power of the mean value.

Optimization of the distribution function of the arrival times with regard to a higher moment of the distribution function means that the latter is produced to be as flat as possible. However, other second optimization values may also be chosen which, for example, ensure that the distribution function of the arrival times fluctuates to a major extent.

In a preferred development, all of the method steps are each carried out for switching element groups from the multiplicity of synchronously driven switching elements which are decoupled from one another.

It is particularly advantageous in this case that the method can be carried out in parallel by virtue of the decoupling. This can be carried out more quickly. When there are a number of switching elements, which may be in the region of one hundred million within a semiconductor circuit, the computational complexity is considerably reduced, and falls in a corresponding manner with the number of decoupled switching element groups.

In one development, the following steps are carried out before step c):
selection of a second reference switching element from the multiplicity of synchronously driven switching elements, which is coupled to the first reference switching element at least via a signal connection, and
definition of a second reference arrival time of the clock signal for the second reference switching element.

The second reference switching element is advantageously in this case selected only from the group of switching elements which are indirectly coupled to the first reference switching element.

In a development, step c) is carried out in each case for the switching elements which are coupled to the first reference switching element and for the switching elements which are coupled to the second reference switching element, ignoring those switching elements for which an arrival time has been defined.

In consequence, the method is carried out iteratively. Starting from a first reference switching element, all of the adjacent and at least indirectly coupled switching elements are associated successively with clock signal arrival times.

At least one switching element is preferably formed from a single switching element or from a group of single switcing elements.

The gathering of two or more single switching elements in a switching element corresponds to a cluster of, for example, gates, which act jointly in a circuit. In this case, a synchronous switching response may be desirable. It is thus often not possible to shift the arrival times while complying with the switching preconditions. Furthermore, such gathering means that the method can be carried out considerably more quickly.

### BRIEF DESCRIPTION OF THE DRAWINGS

The invention will be explained in more detail in the following text using a number of exemplary embodiments and with reference to the drawing, in which:

FIG. 1 shows a flowchart for a method for creation of a layout for a semiconductor circuit;

FIG. 2a shows a schematic illustration of current profiles of switching elements and of the sum of all the current profiles in a synchronously clocked semiconductor circuit;

FIG. 2b shows a schematic illustration of current profiles of switching elements and of the sum of all the current profiles in a semiconductor circuit clocked according to one embodiment of the invention;

FIG. 3 shows a semiconductor circuit with switching elements connected in series;

FIG. 4 shows an example of the distribution of the number of switching elements which switch at the same time within one interval element;

FIG. 5 shows an example of a further distribution of the number of switching elements which switch at the same time within one interval element;

FIG. 6 shows a schematic illustration of profiles of the total current and of local voltage profiles for an ideal load and a real load on the voltage supply; and

FIG. 7 shows a further schematic illustration of current profiles with a real load on the voltage supply.

### DETAILED DESCRIPTION OF PREFERRED EMBODIMENTS OF THE INVENTION

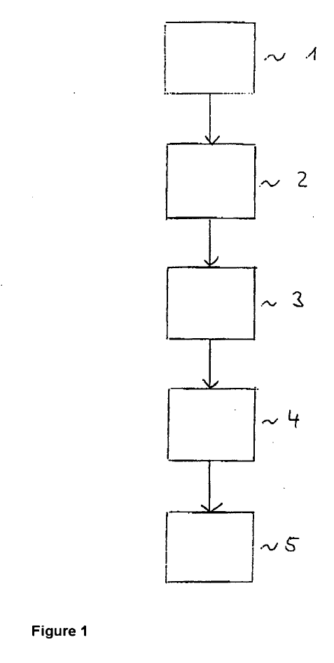

FIG. 1 shows a flowchart of a method for creation of a layout for a semiconductor circuit of one embodiment of the invention. If the semiconductor circuit is created in the form of a layout, it is produced in hardware in the form of a chip. The creation of a layout for a semiconductor circuit takes place in steps which are illustrated schematically in FIG. 1. The procedure starts with a step 1, in which a gate level network list is produced. A floor plan for switching elements and signal connections in the semiconductor circuit is created on the basis of the gate level network list, in a subsequent step 2. A clock tree structure file is created in a subsequent step 3, so that the profile of the signal connections is defined, and the clock tree structure is placed on the layout, in a subsequent step 4. It is then possible to output the layout of the semiconductor circuit, which indicates the position of the switching elements, of the signal connections and of the clock tree structure in a monolithic semiconductor structure. The layout is used to produce the semiconductor structure as a chip.

The layout is created on the basis of a gate level input network list, from which the logic circuit on which the semiconductor circuit will be based is known. The gate level input network list describes all the signal connections between the switching elements that are used. Method steps for the creation of a gate level input network list such as this are known to those skilled in the art. In addition, delay time requirements for complex units comprising a number of switching elements, so-called high-level timing constraints, are necessary for the design of the layout. These indicate, inter alia, the clock frequency and the requirements for the transmission and arrival times of input and output signals at the circuit edge.

A switching element library may contain switching times and layout information for the switching elements. The input data generally also includes a library of the signal connections between the switching elements, with associated wiring parameters such as capacitances or resistances of the signal connections.

Starting from the input data, the switching elements, that is to say single switching elements or switching element groups, are placed within the semiconductor circuit during the creation of a floor plan for the layout. The switching elements are placed on the basis of wiring and delay-time criteria on the signal connections, in which case it is initially possible to assume that the switching elements are driven synchronously.

Before the definition of the final profile of the signal connections and the placing of a clock tree in the semiconductor circuit, the arrival times of a clock signal at the switching elements are optimized, and are stored in a clock tree structure file. The clock tree may in this case be in the form of a clock distribution structure (clock trunk) with no branches, or with scarcely any branches, or in the form of a tree-like structure (clock tree). Delay elements which are connected in the clock tree are used to increase the delay time of the clock signal, in order that this clock signal is supplied to the appropriate switching element at the arrival time defined in the clock tree structure file.

The clock signal must arrive at a switching element at a time within a clock signal arrival interval for that switching element in order to satisfy the set-up and hold conditions at this switching element. The following text contains a description, by way of example, of how the clock signal arrival intervals of the switching element and the switching elements are determined if a reference arrival time has already been defined for a reference switching element.

A first edge value T21 is known from the reference arrival time as the time of the first rising edge of the clock signal at the reference switching element. A second edge value T22 indicates the time of the subsequent rising edge of the clock signal at the reference switching element, which corresponds to the first edge value T21 shifted through one clock period duration T_{dk}.

A permissible time interval for a third edge value T11 for a switching element which is connected immediately upstream in the signal path is determined as the time of the first rising edge of the clock signal at the upstream switching element. This takes account of the maximum signal delay time maxl2 and the minimum signal delay time minl2 in the signal connection between the reference switching element and the upstream switching element. A set-up time set2 and a hold time hold2 for the reference switching element are stored in the switching element library. The set-up precondition at the reference switching element leads to the inequality:
max12+set2≦T22−T11. (1)

The hold condition at the reference switching element in contrast leads to the inequality:
min12≧T21−T11+hold2. (2)

The clock signal arrival interval for the upstream switching element is thus given by:
T21+hold2−min12≦T11≦T21+T_{dk}−max12−set2 (3)

A permissible time interval for a fourth edge value T31 for a switching element which is immediately downstream in the signal path is determined in the same way as the time of the first rising edge of the clock signal at the downstream switching element. A fifth edge value T32 indicates the time of the subsequent rising edge of the clock signal at the downstream switching element, which corresponds to the first edge value T31 shifted through one clock period duration T_{dk}.

The maximum signal delay time max23 and the minimum signal delay time min 23 in the signal connection between the reference switching element and the downstream switching element are taken into account. A set-up time set3 and a hold time hold3 for the downstream switching element are stored in the switching element library. The set-up precondition for the downstream switching element leads to the inequality:
max23+set3≦T32−T21. (4)

The hold condition at the reference switching element leads, in contrast, to the inequality
min23≧T31−T21+hold3 (5)

The clock signal arrival interval for the downstream switching element is thus given by:
T21+max23+set3−T_{dk}≦T31≦min23+T21−hold3 (6)

Hold and set-up times are characteristics of the switching elements and are in general additionally dependent on signal delay times of the clock signal and of data signals in the switching elements. This dependency can be stored in the switching element library, and can likewise be taken into account in the calculation.

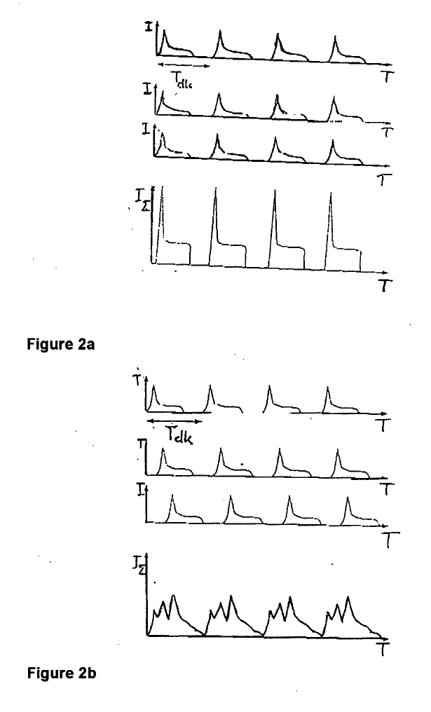

The first three curves in both FIG. 2a and FIG. 2b show current profiles I at the voltage supply inputs of three switching elements. The curves which are illustrated in detail show the current profile I on the ordinate, which is plotted against a time axis T on the abscissa.

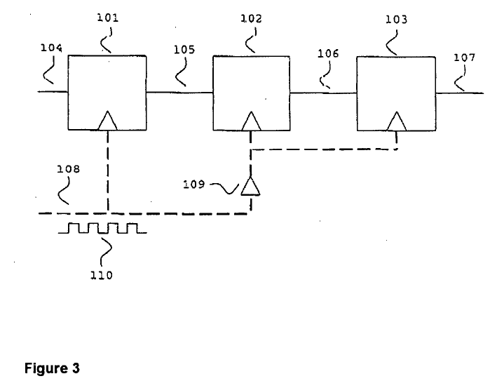

By way of example, FIG. 3 shows a semiconductor circuit with three series-connected switching elements 101, 102, 103 according to an embodiment of the invention. The switching element 101 is connected via a signal connection 104 to an input signal, and is coupled via a signal connection 105 to the switching element 102. The switching element 102 is coupled by means of the signal connection 106 to the switching element 103, which is itself connected via a signal connection 107 to a signal output. The three switching elements 101, 102, 103 each have a clock input, to which a clock signal 110 is supplied via a clock tree 108. The clock tree 108 has a delay element 109, which increases the delay time of the clock signal 110 by a specific time period.

The voltage supply for the three switching elements 101, 102, 103 has not been illustrated, for clarity reasons. Normally, all of the switching elements 101, 102, 103 are supplied with a respective operating voltage from a common voltage supply unit. During signal processing, a total current which comprises the sum of the operating currents of the individual switching elements 101, 102, 103 flows at the output of this voltage supply unit.

A current profile I at a voltage supply input of a switching element has charge-reversal current surges when one signal output of the switching element changes the output potential. In the illustrated example, it is assumed for the sake of simplicity that a charge-reversal current surge occurs only when a change takes place from a “low” to a “high” potential. The magnitude of the essentially flat plateau of the current profile I which follows the charge-reversal current surge corresponds to a current which is required for charge reversal of logic stages which are connected downstream from the switching element in the signal path. The charge-reversal current surge occurs when the switching element switches. A changed signal at the signal output propagates successively through subsequent logic stages, thus producing charge-reversal currents at the individual logic stages.

Both figures show a total current IF underneath the illustrated current profile I for the switching elements. This total current I_{Σ} flows at the common voltage supply for the switching elements, and is in each case formed by superimposition of the current profiles I illustrated above it.

In the situation illustrated in FIG. 2a, all of the switching elements are driven exactly in synchronism. The maximum total current I_{Σ} is thus formed by adding the individual surge currents in the current profiles I.

The current profiles I illustrated in FIG. 2b differ from those shown in FIG. 2a in that the switching elements under consideration are driven quasi-synchronously. The clock signal reaches the clock inputs of the switching elements at different arrival times, which are shorter than the period duration T_{dk}. The profile of the total current I_{Σ} is thus smooth, and is distributed over a broader time period. In consequence, the total current I_{Σ} does not have any pronounced current surges. The common voltage supply for the switching elements can thus be designed for a lower maximum current draw than that in the situation shown in FIG. 2a. The low current drawn is important, particularly in semiconductor circuits for mobile applications, such as mobile telephones.

Arrival times for the clock signal 110 at the switching elements 101, 102, 103 are defined by first of all selecting a reference switching element 102 at which a reference arrival time is defined. This reference point may first of all be used, by way of example, as the basis for determining the clock signal arrival intervals for those nearest neighbors to the reference switching element 102 which are directly connected via signal connections 104, 105, 106, 107 to the first reference switching element 102. An arrival time for the corresponding switching elements 101, 102, 103 can be defined within the clock signal arrival intervals. The switching elements 101, 102, 103 are used as the starting point for determination of the clock signal arrival intervals for their nearest neighbors. The method is continued iteratively until an arrival time has been defined for a network comprising switching elements 101, 103 which are all connected directly or indirectly to the first reference switching element 102. Ideally, an attempt is made at this stage to choose the distribution of the arrival times to be as broad as possible within one clock period duration T_{dk}. The same method steps are carried out for further networks of switching elements which are completely decoupled from the first reference switching element 102. In this case, one switching element 102 is in each case selected as the reference switching element associated with that network. In this case, the method steps can be carried out in parallel for each network of switching elements, or else may be carried out sequentially.

In order to ensure that the method converges rapidly, it is possible to choose two or more switching elements 101, 102, 103 within a network as the reference switching elements and to define a reference arrival time for each of them at the start of the method. The clock signal arrival time intervals for each of the nearest neighbors can then be determined, starting from them. This method can thus also be carried out in parallel, and it is possible to ensure that the arrival time for one switching element 101, 102, 103 within the network is defined only once.

In this case, it is advantageous for the reference switching elements not to be connected directly via signal connections 104, 105, 106, 107, but for further switching elements 101, 102, 103 to be arranged on the signal paths which connect them.

Once all of the arrival times for one or more networks have been defined, then these arrival times can once again be shifted within the clock signal arrival time intervals in order to distribute them optimally. In this case, the clock signal arrival time intervals can optionally be recalculated after each method step.

The distribution of the arrival times of the clock signal 110 at the switching elements 101, 102, 103 within the specific clock signal arrival intervals is achieved by minimizing an optimization value.

In one refinement, the optimization process is carried out by trial and error shifting of a number of arrival times.

Once a number of trials have been carried out, those arrival times which come closest to a condition for a minimum optimization value are stored in the clock tree structure file.

A time interval of one clock period duration T_{dk} is considered in order to determine the optimization value. The time interval is subdivided into kₘₐₓ interval elements of the same length with start times Tₖ, where k=1, . . . , kₘₐₓ. The variable Nₖ is used to specify the number of switching elements 101, 102, 103 which switch within the time interval (tₖ, tₖ₊₁). The expected value <N> for the switching elements 101, 102, 103 which switch within an interval element is in this case determined using the equation:

$$〈 N 〉 = \frac{1}{{k}_{max}} {\sum }_{k = 1}^{k max} {N}_{k} . \qquad ( 7 )$$

Initially, it is possible to use a method to reach the minimum optimization value more quickly. For this purpose, the areas in the distribution Nₖ where Nₖ><N> are entered in a first list PLUS, and the areas where Nₖ<<N> are entered in a second list MINUS. The first list PLUS can also be subdivided into a first sublist PLUS1 and into a second sublist PLUS2, with the interval elements k with the greatest discrepancies (Nₖ−<N>) being in the first sublist PLUS1. An analogous procedure can be used for the list MINUS, with this list being subdivided into a third sublist MINUS1 and a fourth sublist MINUS2. First of all, the areas of the greatest discrepancies are compensated for, with arrival times always being changed such that undershoot areas within the sublist MINUS are filled from overshoot areas within the first list PLUS. An optimization value can preferably be used in order to assess the result.

In one refinement, a first optimization value M is defined by the variable
M=<N²>−<Nₖ>² (8)

If the variable Nₖ has a broad distribution, this first optimization value M is linked to the variance VAR of the distribution function as follows:

$$VAR = \frac{1}{{k}_{max} - 1} {\sum }_{k = 1}^{k max} {( {N}_{k} - 〈 N 〉 )}^{2} \approx 〈 {N}_{k}^{2} 〉 - {〈 N 〉}^{2} . \qquad ( 9 )$$

With a distribution of the variable Nₖ, the best effect is obviously achieved if the expected value <N> assumes the value 1, and thus, as far as possible, only one switching element 101, 102, 103 is switched in each interval element. This is dependent on the first optimization value M assuming a minimum value at the same time. However, a multiplicity of computation steps are required to achieve this aim. In general, the expected value is chosen to be <N>>>1.

In a further refinement, a second optimization value M2 is defined as

$$M2 = {\sum }_{k = 1}^{k max} {( {N}_{k} - 〈 N 〉 )}^{4} \qquad ( 10 )$$

The second optimization value M2 can thus also depend on higher moments, in the case described above up to the fourth moment, of the distribution of the variable, Nₖ. The second optimization value M2 stresses distribution peaks in comparison to the first optimization value M1, and is thus a preferred measure for the quality of the distribution function.

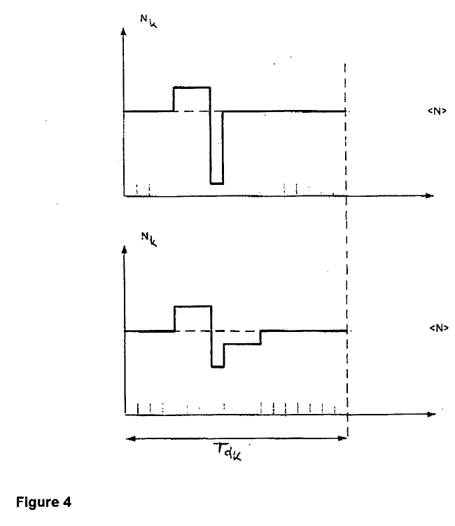

FIG. 4 shows distributions of the variable, Nₖ over one clock period duration T_{dk}. As shown in FIG. 3, the two curves in this case have differently pronounced fluctuations of the variable Nₖ about the expected value <N>. Both the first optimization value M1 and the second optimization value M2 indicate the upper curve with major fluctuations about the expected value <N> as the worse constellation in comparison to the lower curve, which does not fluctuate severely in this way.

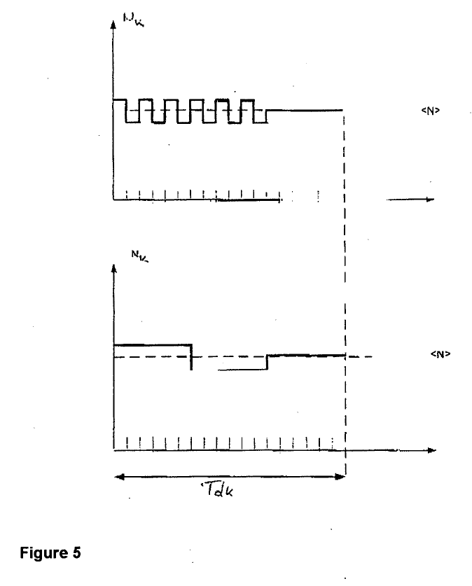

FIG. 5 shows two profiles of the variable Nₖ over one clock period duration T_{dk}, which produce the same numerical value for the first optimization value M1 and for the second optimization value M2 within different time scales with the same amplitude about the expected value <N>. However, this result is not desirable, because the amplitude of the current surge in actual circuits is smoothed by capacitances in the supply lines of the voltage supply.

In an alternative refinement, a third optimization value M3 is defined as:

$$M3 = - \frac{1}{{k}_{max}} {\sum }_{k = 1}^{{k}_{max}} {( {N}_{k} - {N}_{( k + 1 ) mod {k}_{max}} )}^{2}$$

Minimizing the third optimization value M3 corresponds to a distribution function which differs as much as possible from one interval element to the next in the variable Nₖ. This optimization method preferably results in the selection of a distribution in which the variable Nₖ fluctuates severely about the expected value <N>.

The advantage of choosing the third optimization value M3 is justified by the characteristics of actual semiconductor circuits. In an actual circuit, the maximum amplitudes of the current surges are smoothed by capacitances in supply lines for the voltage supply.

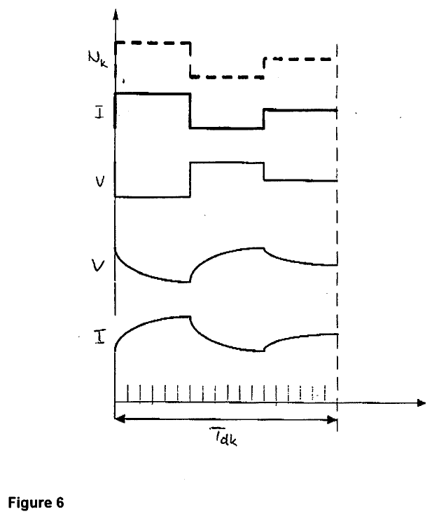

FIG. 6 shows, schematically, how the total current at the voltage supply is smoothed using resistances and capacitances by means of actual supply lines for the voltage supply for the switching elements 101, 102, 103 when a predetermined local load change occurs. The individual illustrated curves each show different variables on the ordinate, such as the variable Nₖ, a current or a voltage, whose zero points are shifted with respect to one another. The time is plotted on the abscissa, and the illustration shows one complete clock period duration T_{dk}.

In this case, the upper curve shows the distribution function for the variable Nₖ. This distribution function is essentially proportional to the current profile (illustrated underneath it) for the total current for the ideal case, in which only a resistive load is applied to the voltage supply. A corresponding local voltage profile at a switching element is illustrated as the third curve, seen from above. This profile is the reciprocal of the current profile of the surge current.

The lowermost curve shows the current profile of the total current I_{Σ} for an actual semiconductor circuit. In this case, the profile of the curve is smoothed on steep edges of the ideal current profile by the capacitances that exist. The curve above this represents the local voltage which is applied to a switching element in this actual case.

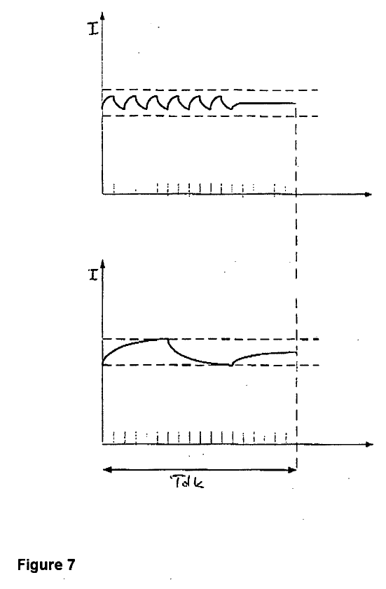

FIG. 7 shows current profiles I for the profiles of the variable Nₖ shown in FIG. 4 over one clock period duration T_{dk} in an actual semiconductor circuit. As can be seen, the maximum peak current on the upper curve is lower than that on the lower curve.

In order to achieve an optimum distribution for the variable Nₖ, it is possible to use a two-stage method in which the arrival times are first of all shifted within the clock signal arrival intervals such that the first optimization value M1 or the second optimization value M2 is minimized. In this case, there are various configurations of the arrival times which result in the same minimum values for the first optimization value M1 or for the second optimization value M2. The third optimization value M3 is calculated for each of these configurations, and one of the configurations is chosen, for which the optimization value M3 is a minimum.

Once the arrival time has been optimized, the final wiring for the clock tree 108 is defined, so that the layout of the semiconductor circuit with respect to the clock tree structure has been designed.

By way of example, the following text describes two different embodiments as method procedures for the method described above.

A first method procedure is based on the approach of connecting one switching element to the clock tree, and of then successively including further elements in the forward and backward directions. This comprises the following method steps:
1.) Initial placing of the switching elements and production of a provisional circuit layout; the provisional signal connections are in this case suitable for calculating increases in the delay time for a data signal, but in general do not associate in any detailed forms with, for example, the metal layers.
2.) Connection of an initial switching element to the clock tree and, if required, necessary changes may be made to the provisional signal connections; drivers and delay elements may be providently installed in the signal connections, and can be removed again subsequently.
3.) Determination of the permissible arrival times for the predecessor and successor switching elements connected via signal connections.
4.) Supply of the clock signal at the specific arrival times to the predecessor and/or successor switching element, taking into account the clock signal arrival intervals and an optimization criterion, such as minimizing the first or second optimization value.
5.) Repetition from 3.) for adjacent switching elements.

A second method procedure is based on a repeated optimization step. This comprises the following method steps:
1.) Initial placing of the switching elements and production of a provisional circuit layout; the provisional signal connections are in this case suitable for calculating increases in the delay time for a data signal, but in general do not associate in any detailed forms with, for example, the metal layers.
2.) Connection of an initial switching element to the clock tree and, if required, necessary changes may be made to the provisional signal connections; drivers and delay elements may be installed in advance in the signal connections, and can be removed again subsequently.
3.) Determination of the arrival times for the predecessor and successor switching elements connected via signal connections, during which process the clock signal arrival times must not be infringed.
4.) Supply of the clock signal at the specific arrival times to the predecessor and/or successor switching element, taking into account the clock signal arrival intervals and an optimization criterion, such as minimizing the first or second optimization value.
5.) Reproduction of the permissible ranges for the arrival times from 3.) by removal and/or addition of delay elements in the signal connections and/or in the clock tree—withdrawal of the connection according to 4.) if this is not possible.
6.) Repetition of the method steps from 3.).

The methods specified above can be implemented as a computer program. They can thus be run by a processor, for example in a computer. The computer program may be stored in a computer-readable storage medium.

1-18. (canceled)

19. A method for computer-aided creation of a clock tree structure file for a semiconductor circuit, which has a plurality of synchronously driven switching elements and a plurality of signal connections, the method comprising the steps of:
a) selecting a first reference switching element from the plurality of synchronously driven switching elements;
b) defining a first reference arrival time of a clock signal for the first reference switching element;
c) determining a clock signal arrival interval for at least one switching element from the plurality of synchronously driven switching elements, which is coupled to the first reference switching element via at least one of the plurality of signal connections;
d) defining an arrival time of a clock signal for the at least one switching element within the clock signal arrival interval, whose value is not the same as the first reference arrival time; and
e) storing the first reference arrival time and the defined arrival time in the clock tree structure file.

20. The method as claimed in claim 19, wherein the clock signal arrival interval is determined by taking into account the first reference arrival time and a set-up time and/or a hold time of the first reference switching element.

21. The method as claimed in claim 19, wherein step c) is repeated at least for one further switching element from the plurality of synchronously driven switching elements, which further switching element is coupled to the first reference switching element via at least one signal connection, and wherein a respective arrival time is defined within the respective clock signal arrival interval, and is stored in the clock tree structure file.

22. The method as claimed in claim 19, wherein step c) is repeated for each of the switching elements from the plurality of synchronously driven switching elements which are each coupled to the first reference switching element via at least one signal connection, and wherein respective arrival times are defined within the respective clock signal arrival intervals and are stored in the clock tree structure file.

23. The method as claimed in claim 21, wherein the clock signal arrival intervals are determined taking into account the arrival times and set-up times and hold times of the switching elements, whose arrival times are already defined.

24. The method as claimed in claim 21, wherein the arrival times are defined within the clock signal arrival intervals such that a first optimization value, which is determined from the arrival times, is determined to be a minimum.

25. The method as claimed in claim 24, wherein the first optimization value is chosen such that a minimum first optimization value corresponds to a maximum variance of a statistical distribution function of the arrival times.

26. The method as claimed in claim 24, wherein the arrival times are defined within the clock signal arrival interval such that the first optimization value is determined to be a minimum, and the arrival times are then shifted within the clock signal arrival intervals such that a second optimization value, which is determined from the arrival times, is determined to be a minimum.

27. The method as claimed in claim 26, wherein the second optimization value is chosen such that a minimum second optimization value corresponds to a maximum discrepancy between a fourth moment of a statistical distribution function of the arrival times and a fourth power of a mean value.

28. The method as claimed in claim 19, wherein all of the method steps are carried out for each of switching element groups from the plurality of synchronously driven switching elements, which are decoupled from one another.

29. The method as claimed in claims 19, further comprising the following steps, which are carried out before step c):
selecting a second reference switching element from the plurality of synchronously driven switching elements, which is coupled to the first reference switching element via at least one of the signal connections; and
defining a second reference arrival time of the clock signal for the second reference switching element.

30. The method as claimed in claim 29, wherein the second reference switching element is selected only from the group of switching elements which are indirectly coupled to the first reference switching element.

31. The method as claimed in claim 29, wherein step c) is carried out in each case for the switching elements which are coupled to the first reference switching element and for the switching elements which are coupled to the second reference switching element, ignoring those switching elements for which an arrival time has been defined.

32. The method as claimed in claim 30, wherein step c) is carried out in each case for the switching elements which are coupled to the first reference switching element and for the switching elements which are coupled to the second reference switching element, ignoring those switching elements for which an arrival time has been defined.

33. The method as claimed in claim 19, wherein at least one switching element is formed from a single switching element or from a group of single switching elements.

34. A method for computer-aidedly creating a layout for a semiconductor circuit, comprising the steps of:
using the method of claim 19 to create a clock tree structure file; and
defining placement and layout of a clock tree within the semiconductor circuit based on the clock tree structure file.

35. An apparatus for creating a clock tree structure file, comprising a processor, which is designed to carry out the method steps of claim 19.

36. A computer-readable storage medium, in which a computer program for creation of a clock tree structure file is stored, and which, when it is run by a processor, has the method steps as claimed in claim 19.

37. A computer-readable storage medium, in which a computer program for creation of a layout for a semiconductor circuit is stored, and which, when it is run by a processor, has the method steps as claimed in claim 34.
